(19) United States
(12) Patent Application Publication
(10) Pub. No.: US 2016/0167188 A1
(43) Pub. Date: Jun. 16, 2016

(54) COLLETS AND TOOL HOLDER ASSEMBLIES EMPLOYING THE SAME

(71) Applicant: Kennametal Inc., Latrobe, PA (US)

(72) Inventors: Danny Ray DAVIS, Asheboro, NC (US); Leonid Sharivker, Naharia (IL)

(21) Appl. No.: 14/568,463

(22) Filed: Dec. 12, 2014

(51) Int. Cl. B24B 3/24; B23B 31/20; B23B 31/11

(52) U.S. Cl. CPC B24B 3/247; B23B 31/11; B23B 31/20; B23B 2231/2013; B23B 2231/2083

(57) ABSTRACT

In one aspect, collets are described herein employing a central bore having a stepped architecture. For example, a collet described herein comprises a clamping portion having a central bore for receiving a coupling portion of a cutting tool or cutting tool blank. The central bore has a stepped architecture comprising an inner section of first diameter, a transition section of second diameter, and an outer section of third diameter.

### FIELD

The present invention relates to tool holder assemblies and, in particular, to tool holder assemblies employing a collet.

### BACKGROUND

Tool holder assemblies and collets configured for use with interchangeable cutting or machining tools provide a number of process efficiencies. A smaller number of machine spindles, for example, can be employed for a larger variety of machining operations, and downtime between various cutting tasks can be reduced by decreased need to switch apparatus for each machining application. Additionally, mechanical working of a cutting tool or cutting tool blank to provide or restore one or more cutting edges similarly benefits from such process efficiencies. In order to realize the foregoing efficiencies, tool coupling systems and spindle connector assemblies must provide secure connection with minimal tool change downtime while maintaining desired operating tolerances.

Several approaches to securely retaining tools for rotary cutting applications utilize reducer sleeves or collets for receiving differently sized or shaped tool shanks. Reducer sleeves and/or collets, however, can present deficiencies in maintaining tolerances for radial runout and grip. Tool holder assembly design continues to evolve in response to the changing demands of tool making and machining applications, thereby calling for the development of new tool holder configurations

### SUMMARY

In one aspect, collets are described herein employing a central bore having a stepped architecture. For example, a collet described herein comprises a clamping portion having a central bore for receiving a coupling portion of a cutting tool or cutting tool blank. The central bore has a stepped architecture comprising an inner section of first diameter, a transition section of second diameter, and an outer section of third diameter. In some embodiments, the inner section is the innermost stepped section of the collet. Similarly, in some embodiments, the outer section is the outermost stepped section of the collet.

In another aspect, tool holder assemblies are described herein. A tool holder assembly comprises a housing, a collet, and a cutting tool or cutting tool blank having a coupling portion. The housing defines a socket and is configured or adapted for connection and rotation with a spindle about an axis of rotation. The collet is, positioned in the socket and includes a clamping portion having a central bore of stepped architecture. The stepped architecture of the central bore comprises an inner section of first diameter, a transition section of second diameter, and an outer section of third diameter. The cutting tool or cutting tool blank has a coupling portion positioned in the central bore such that the surfaces of the inner section and transition section engage the coupling portion. In some embodiments, the inner section is the innermost stepped section of the collet and the outer section is the outermost stepped section of the collet.

In a further aspect, methods of making cutting tools are described herein. A method comprises providing a cutting tool blank having a coupling portion and a blank portion and securing the coupling portion of the cutting tool blank in a clamping portion of a collet. The clamping portion of the collet has a central bore of stepped architecture comprising an inner section of first diameter, a transition section of second diameter, and an outer section of third diameter. The method further comprises grinding the blank portion to provide a working portion of the cutting tool having one or more cutting edges.

### BRIEF DESCRIPTION OF THE DRAWINGS

FIG. 1 illustrates a perspective view of a collet according to one embodiment described herein.

FIG. 2A illustrates a cross-sectional view of a collet according to one embodiment described herein.

FIG. 2B illustrates a sectional view of a portion of the collet of FIG. 2A.

FIG. 3 illustrates a perspective view of a tool holder assembly according to one embodiment described herein.

### DETAILED DESCRIPTION

Embodiments described herein can be understood more readily by reference to the following detailed description and examples and their previous and following descriptions. Elements and apparatus described herein, however, are not limited to the specific embodiments presented in the detailed description. It should be recognized that these embodiments are merely illustrative of the principles of the present invention. Numerous modifications and adaptations will be readily apparent to those of skill in the art without departing from the spirit and scope of the invention.

### I. Collets

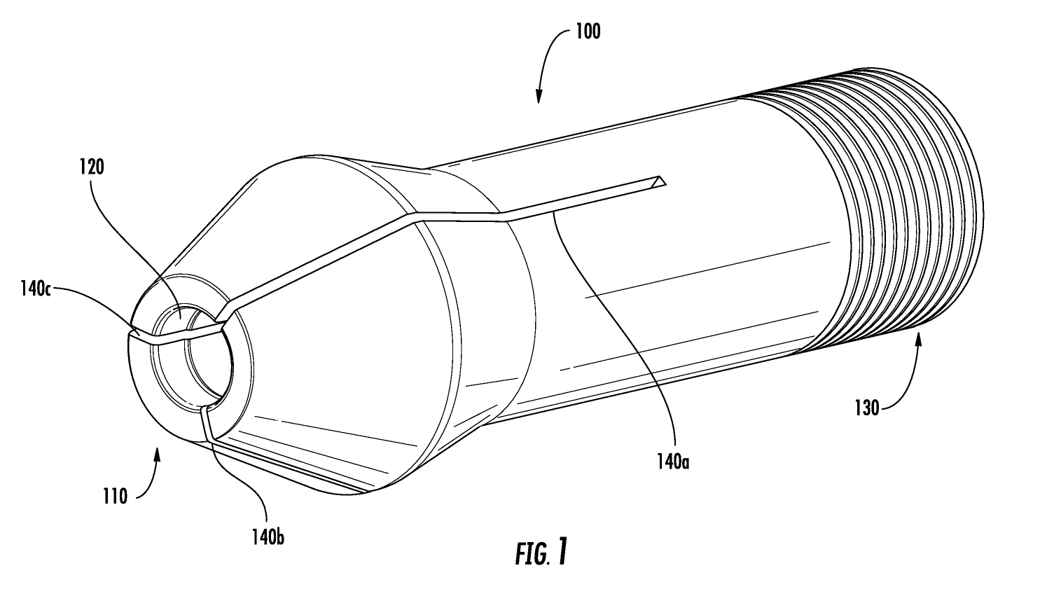

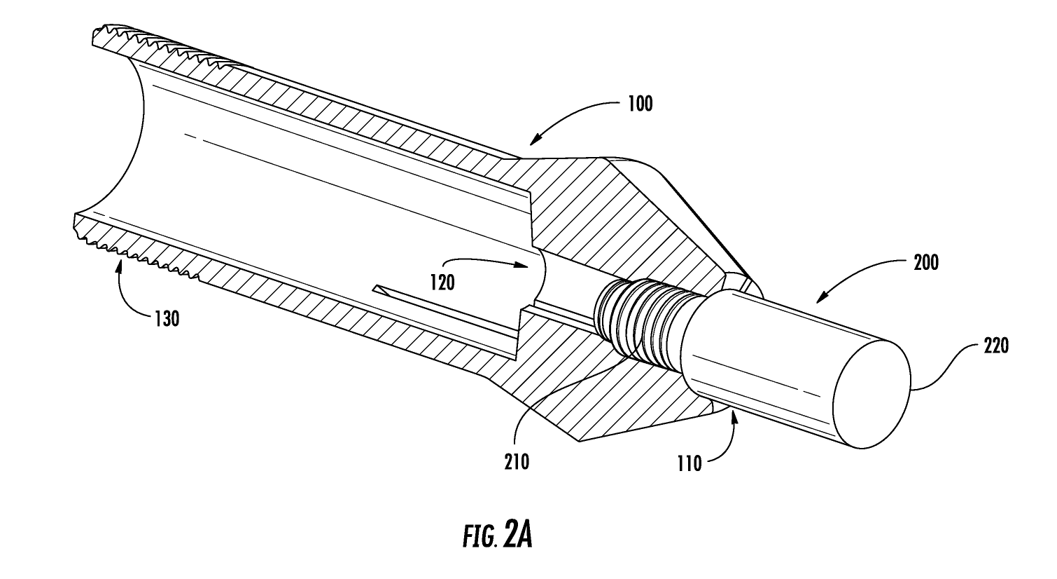

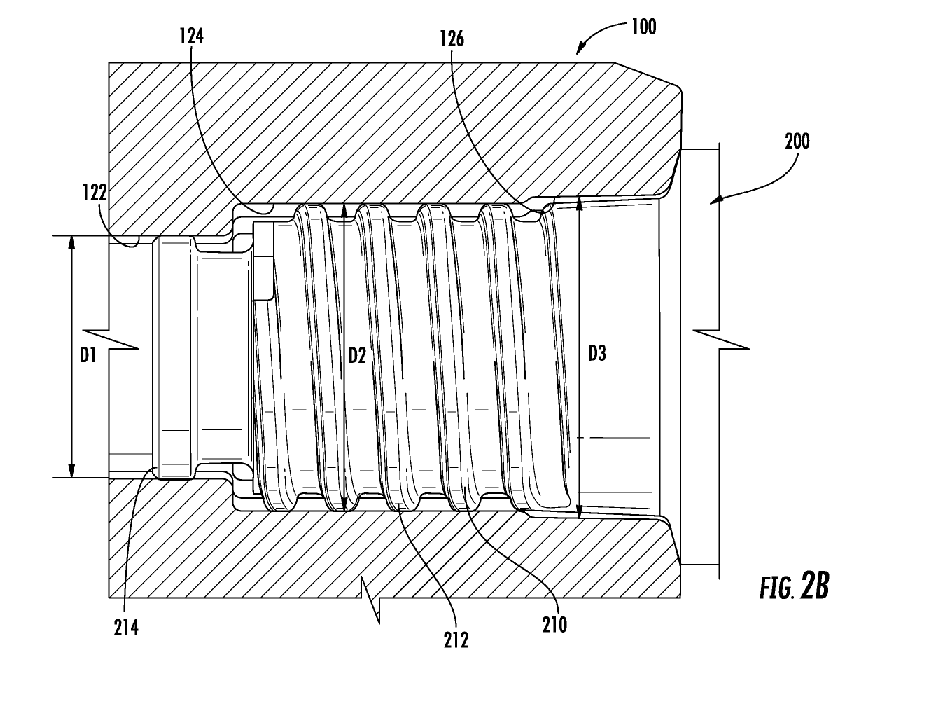

Referring now to FIGS. 1, 2A and 2B, there is illustrated a collet, generally designated as reference number 100, in accordance with one embodiment described herein. As provided in FIGS. 1, 2A and 2B, the collet (100) comprises a clamping portion (110) having a central bore (120) for receiving a coupling portion (210) of a cutting tool or cutting tool blank (200). The central bore (120) has a stepped architecture comprising an inner section (122) of first diameter (D1), a transition section (124) of second diameter (D2) and an outer section (126) of third diameter (D3).

As illustrated in FIG. 1, the collet (100) includes a clamping portion (110) and socket engaging portion (130). The socket engaging portion (130) has architecture operable to engage the socket of a tool holder housing in such a manner that axial pull-out or movement of the collet (100) relative to the socket is limited. Such architecture can include a threaded portion as illustrated in FIG. 1 or any other configuration adapted for such purpose. The collet (100) can have any desired cross-sectional shape. In the embodiment illustrated in FIG. 1, at least a portion of the collet (100) is of circular cross-sectional shape, however other shapes are also contemplated, such as polygonal. The collet (100) further comprises one or more slits or slots (140a, 140b, 140c) for providing a clamping or gripping action on a cutting tool or cutting tool blank upon the application of force to outer surfaces of the collet (100). For example, a collet (100) having such slits or slots (140a, 140b, 140c) can be configured or adapted to engage with a variety of chucking assemblies, such as a hydraulic chuck, wherein a circumferential force is applied to the outer diameter surface of the collet (100) to secure a cutting tool or cutting tool blank.

A collet (100) described herein comprises a central bore (120) having a stepped architecture. As illustrated in FIGS. 2A and 2B, the stepped architecture comprises an inner section (122) of first diameter (D1), a transition section (124) of second diameter (D2) and an outer section (126) of third diameter (D3). The first, second, and third diameters (D1, D2, D3) can have any relationship to one another not inconsistent with the objectives of the present invention. For example, in some embodiments, the first diameter (D1) is less than the second diameter (D2), and the second diameter (D2) is less than the third diameter (D3). In certain cases, the first, second and/or third diameters (D1, D2, D3) can be configured to engage surfaces of the coupling portion (210) of the cutting tool or cutting tool blank (200). As illustrated in

FIG. 2B, the first diameter (D1) of the inner section (122) and the second diameter (D2) of the transition section (124) can be of dimensions for engaging surfaces of the coupling portion (210) of the cutting tool or cutting tool blank (200). In some embodiments, the third diameter (D3) is of dimension to provide radial clearance with the coupling portion (210) of the cutting tool or cutting tool blank (200). In other embodiments, the third diameter (D3) can be configured to engage the coupling portion (210) of the cutting tool or cutting tool blank (200).

Further, in some embodiments, the central bore of a collet described herein can terminate in a tapered surface. Such a configuration may be adapted or configured to engage a complementary tapered portion on a cutting tool or cutting tool blank. FIG. 2B illustrates a collet and a cutting tool or cutting tool blank demonstrating such an architecture. In other embodiments, the collet and/or cutting tool or cutting tool blank does not include or comprise such a tapered portion.

Collets described herein can provide certain performance characteristics or to conform to tolerance ranges. For example, a collet can be configured to have a runout error within a desired range when engaging a cutting tool or cutting tool blank. For the purposes of the present disclosure, runout error is determined by measurement at a distance of 2(d) from a front end of the collet, wherein d is the diameter of the cutting tool or cutting tool blank. A collet can provide any runout error value not inconsistent with the objectives of the present invention. For example, collet runout error can be selected from Table I.

TABLE I
Value of runout error (mm)
≦0.015
≦0.010
≦0.004
0.004-0.015
0.004-0.010

### II. Tool Holder Assemblies

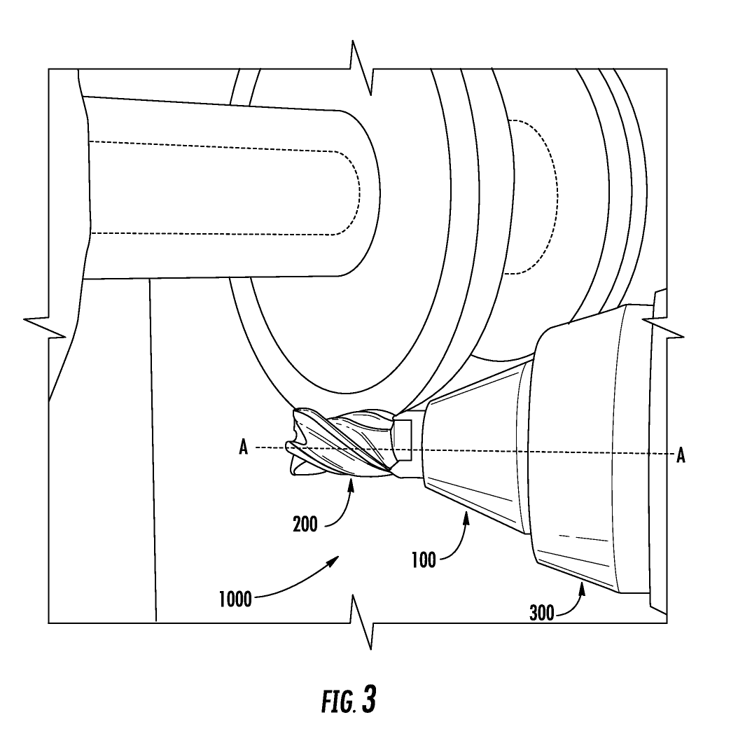

In another aspect, tool holder assemblies are described herein. Referring now to FIG. 3, there is illustrated a tool holder assembly, generally designated 1000, in accordance with one embodiment described herein. The tool holder assembly (1000) comprises a housing (300) for connection and rotation with a spindle (not shown) about an axis of rotation (A-A), the housing (300) defining a socket for receiving or engaging the collet (100). Any socket design can be used, such as a socket configured to engage the collet (100) by application of hydraulic pressure and/or by mechanical joining or fastening, such as by threaded engagement.

As illustrated in FIG. 3, a cutting tool or cutting tool blank (200) is secured by the collet (100) for grinding operations. The cutting tool or cutting tool blank (200) includes a coupling portion for securement in the central bore (120) of the collet (100), as illustrated in FIGS. 2A and 2B. The coupling portion (210) can include a threaded section (212) along a segment or the entire length of the coupling portion (210). In the embodiments of FIGS. 2A and 2B, the threaded section (212) extends less than the full length of the coupling portion (210). Such threaded sections (212) can be configured in any shape or diameter. In FIGS. 2A and 2B, the threaded section (212) is generally cylindrical. In other embodiments, the threaded section can exhibit conical, frustoconical or complex geometrical shape as desired for a particular tool holder assembly configuration. In the embodiments of FIGS. 2A and 2B, surfaces of the transition section (124) engage individual threads of the threaded section (212).

A coupling portion (210) of the cutting tool or cutting tool blank (200) can further comprise a convex tail (214). As illustrated in FIGS. 2A and 2B, the convex tail (214) is defined by a section of relatively larger diameter compared to adjacent coupling portion (210) diameter. Such a configuration results in a raised groove, surface or protrusion and can be provided with such diameter that the convex tail portion (214) engages one or more collet (100) internal surfaces, such as the inner section (122) of a central bore (120). FIGS. 2A and 2B illustrate a tool holder assembly consistent with the foregoing in which the inner section (122) of the central bore engages the convex tail (214), the transition section (124) engages the threaded section (212), and the outer section (126) provides radial clearance relative to the rest of the coupling portion (210).

### III. Methods of Making Cutting Tools

In a further aspect, methods of making cutting tools are described herein. A method of making a cutting tool comprises providing a cutting tool blank having a coupling portion and a blank portion, securing the coupling portion of the cutting tool blank in a clamping portion of a collet, and grinding the blank portion to provide a working portion of the cutting tool having one or more cutting edges. The clamping portion of the collet has a central bore of stepped architecture comprising an inner section of first diameter, a transition section of second diameter, and an outer section of third diameter. Surfaces of the inner section and the transition section of the collet can engage the coupling portion of the cutting tool blank. Further, the transition section can engage a threaded section of the coupling portion. A radial clearance can be provided between the outer section and the coupling portion.

Individual steps of methods described herein can be carried out in any order or in any manner not inconsistent with the objectives of the present invention. Further, any additional steps can be carried out consistent with the present invention. For example, the method can further comprise grinding flutes in the working portion in addition to or in combination with the one or more cutting edges. In some embodiments, the cutting tool blank is rotated during grinding. An example of a portion of a method described herein is illustrated in FIG. 3, in which a cutting tool blank (200) having a coupling portion (not shown) and a blank portion (220 of FIG. 2A) is provided, and the coupling portion is secured in a clamping portion (not shown) of a collet (100). FIG. 3 illustrates an in-process view of the blank portion being grinded to provide a working portion of the cutting tool (200) having one or more cutting edges.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. A collet comprising:
a clamping portion having a central bore for receiving a coupling portion of a cutting tool or cutting tool blank, the central bore having a stepped architecture comprising an inner section of first diameter, a transition section of second diameter and an outer section of third diameter.

2. The collet of claim 1, wherein the first diameter is less than the second diameter, and the second diameter is less than the third diameter.

3. The collet of claim 1, wherein the first diameter of the inner section and the second diameter of the transition section are of dimensions for engaging surfaces of the coupling portion of the cutting tool or cutting tool blank.

4. The collet of claim 3, wherein the third diameter is of dimension to provide radial clearance with the coupling portion of the cutting tool or cutting tool blank.

5. The collet of claim 1 having a runout error of less than 0.010 mm at a distance of 2(d) from a front end of the collet, wherein d is the diameter of the cutting tool or cutting tool blank.

6. The collet of claim 5, wherein the runout error is less than 0.004 mm.

7. The collet of claim 1, wherein the central bore terminates in a tapered surface.

8. A tool holder assembly comprising:
a housing for connection and rotation with a spindle about an axis of rotation, the housing defining a socket;
a collet positioned in the socket, the collet including a clamping portion having a central bore of stepped architecture comprising an inner section of first diameter, a transition section of second diameter and an outer section of third diameter; and
a coupling portion of a cutting tool or cutting tool blank positioned in the central bore, wherein the surfaces of the inner section and transition section engage the coupling portion.

9. The tool holder assembly of claim 8, wherein radial clearance is provided between the outer section and the coupling portion of the cutting tool or cutting tool blank.

10. The tool holder assembly of claim 8, wherein the transition section engages a threaded section of the coupling portion of the cutting tool or cutting tool blank.

11. The tool holder assembly of claim 9, wherein the inner section engages a convex tail of the coupling portion of the cutting tool or cutting tool blank.

12. The tool holder assembly of claim 8, wherein the first diameter is less than the second diameter, and the second diameter is less than the third diameter.

13. The tool holder assembly of claim 8, wherein the collet has a runout error of less than 0.010 mm at a distance of 2(d) from a front end of the collet, wherein d is the diameter of the cutting tool or cutting tool blank.

14. The tool holder assembly of claim 13, wherein the runout error is less than 0.004 mm.

15. The tool holder assembly of claim 8, wherein the central bore of the collet terminates in a tapered surface, and wherein the tapered surface engages a tapered surface on the cutting tool or cutting tool blank.

16. A method of making a cutting tool comprising:
providing a cutting tool blank having a coupling portion and a blank portion;
securing the coupling portion of the cutting tool blank in a clamping portion of a collet, the clamping portion having a central bore of stepped architecture comprising an inner section of first diameter, a transition section of second diameter and an outer section of third diameter; and
grinding the blank portion to provide a working portion of the cutting tool having one or more cutting edges.

17. The method of claim 16, wherein the surfaces of the inner section and the transition section engage the coupling portion of the cutting tool blank.

18. The method of claim 17, wherein the transition section engages a threaded section of the coupling portion.

19. The method of claim 17, wherein a radial clearance is provided between the outer section and coupling portion.

20. The method of claim 16, wherein the first diameter is less than the second diameter, and the second diameter is less than the third diameter.

21. The method of claim 16, wherein flutes are ground in the working portion.

22. The method of claim 16, wherein the cutting tool blank is rotated during grinding.
